(19) United States
(12) Patent Application Publication
(10) Pub. No.: US 2026/0340903 A1
(43) Pub. Date: Oct. 29, 2026

(54) MULTIMEDIA CONTENT CREATION SYSTEM WITH VOICE AND APPEARANCE GENERATION

(71) Applicant: Voila Voice Inc., Austin, TX (US)

(72) Inventors: Abhijit Mishra, Austin, TX (US); Alexander Weisman Mintz, Austin, TX (US)

(21) Appl. No.: 19/654,395

(22) Filed: Apr. 21, 2026

Related U.S. Application Data
(60) Provisional application No. 63/793,490, filed on Apr. 23, 2025.

(51) Int. Cl. G06T 11/60; G06F 40/166; G10L 13/027; G10L 13/033; G10L 21/055

(52) U.S. Cl. CPC G06T 11/60; G06F 40/166; G10L 13/027; G10L 13/033; G10L 21/055; G06T 2200/24

(57) ABSTRACT

Techniques for generating audiovisual content from source materials are disclosed. A system processes source content, such as documents including text, images, audio, or video, to generate a transcript, speech audio, and corresponding video. The system processes speech and/or video recordings to generate transcripts and/or user data including voice characteristic and/or visual appearance data. The speech audio is generated using stored voice characteristics to produce cloned speech. Video content including an avatar based on the visual appearance data is generated and synchronized with the speech audio to produce an audiovisual output. The system may further generate structured outputs, including summaries, salient phrases, and assessment content, and synchronize such outputs with the audiovisual output. In some implementations, the system segments the audiovisual output into navigable portions, supports interaction via query-based interfaces, and/or adapts output based on instructions, resulting in efficient creation and presentation of customized multimedia content.

### CROSS-REFERENCE TO RELATED APPLICATION

This application claims the benefit of U.S. Provisional Patent Application 63/793,490, filed Apr. 23, 2025, which is hereby incorporated by reference.

### TECHNICAL FIELD

The present disclosure generally relates to multimedia content creation, including speech and avatar generation.

### BACKGROUND

Various tools exist for generating speech, avatars, and other multimedia content. In recent years, educators and content creators have increasingly relied on digital tools to produce instructional videos for online learning environments. These workflows often involve multiple discrete steps, including script preparation, audio recording, video editing, slide synchronization, translation, and post-production refinement, many of which require specialized technical skills and significant manual effort. As a result, producing high-quality, multilingual educational video content remains time-consuming and resource-intensive, particularly when scaling across multiple languages or formats.

Some systems include text-to-speech generation, video generation, or machine translation. However, such systems are typically fragmented and limited in scope. For example, some platforms have users manually align slides and narration, while others facilitate using generic images or video insertion. Additionally, traditional systems produce content that is static in both content and language. Consequently, conventional multimedia content generation often requires substantial manual input and provides static, limited experiences.

Some speech transformation systems have been used in education and online learning. Such systems allow educators to translate course material into multiple languages or summarize lengthy educational texts. Conventional systems that translate, summarize, or enhance content based on predefined language rules often produce results that are inaccurate.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The implementations are illustrated by way of example and not by way of limitation in the figures of the accompanying drawings. It should be noted that references to “an” or “one” implementation in this disclosure are not necessarily to the same implementation, and they mean at least one. In the drawings, in accordance with one or more implementations:

FIG. 1 illustrates a user profile data generation and storage subsystem of a multimedia content creation system.

FIG. 2 illustrates a block diagram of a content creation subsystem of the multimedia content creation system.

FIG. 3 illustrates an interactive tutorial subsystem of the multimedia content creation system;

FIG. 4 illustrates a set of operations for multimedia content creation, presentation, and querying;

FIG. 5 illustrates a networked computing environment for deploying a multimedia content creation system;

FIG. 6 illustrates an example viewer graphical user interface (GUI) for a multimedia content creation system; and

FIG. 7 illustrates a block diagram of a computing system.

### DETAILED DESCRIPTION

### 1. SUMMARY

Conventional systems for generating educational multimedia content suffer from significant fragmentation and inefficiency. Existing tools typically address only isolated aspects of a content creation pipeline, such as translation, summarization, voice synthesis, or avatar generation, and typically require users to manually coordinate multiple systems to produce a final output. This results in time-intensive workflows, often requiring many hours per video, particularly when creating multilingual content. Additionally, such systems frequently rely on rigid translation models that fail to preserve domain-specific terminology, stylistic nuance, and instructional intent. Further, conventional systems lack integration with source materials such as presentation slides, do not preserve a creator’s natural voice and appearance, and generally fail to provide interactive learning features such as real-time tutoring or contextual question answering.

One or more implementations overcome such limitations by providing an integrated system that automates end-to-end transformation of source documents into interactive, multilingual audiovisual content while preserving the creator’s natural voice and visual likeness. In particular, the system processes input documents (e.g., slides or text) using a multimodal content generation pipeline to produce speaker notes, summaries, and related metadata, generates speech in a selected language, and/or applies voice cloning to replicate a user’s voice characteristics. The system further generates a lip-synced avatar video of the user, synchronizes the audiovisual elements with the original content, and/or automatically segments the resulting presentation into coherent video units. In addition, an interactive artificial intelligence (AI) tutor subsystem facilitates real-time, context-aware engagement with viewers, supporting both text and voice interactions based on the generated content. By integrating these components into a unified workflow, the system reduces manual effort, improves consistency and fidelity of generated content, and enables scalable production of personalized, multilingual educational experiences.

One or more implementations provide a system for creating audiovisual content. The system includes a user interface that has an input receiver. The user interface allows a first input from a user. In some implementations, the first input must include text and optionally includes audio and/or video data. In other implementations, the first input includes audio and/or video data and the system uses automated speech recognition to generate text from the audio and/or video data. In some implementations, the system receives a second input instructing the system about how to process the first input into an audiovisual output. The user interface also includes an output display that displays the audiovisual output to the user. The system also includes a content transformation system to create the output. The content transformation system includes a speech transcription engine that processes speech from the first input into a text transcription, a content generator that processes the first input and the second input and generates a speech transcript and summary in a target language, a speech generation engine that converts the speech transcript into an audio output in the target language, a speech cloning engine that converts the audio output into a cloned audio output in the target language, a video generator that generates a video output of an avatar of the user speaking the cloned audio output in the target language, and an output generator that generates illustrative images and text in the target language based on the first input, the second input, and the speech transcript. The output generator also synchronizes the summary, the illustrative images, and the text with the video output into a single audiovisual output that is output to the user interface.

One or more implementations provide a method of creating audiovisual content. The method includes providing a user interface. The user interface includes an input receiver that receives a first input from a user, including text, audio and/or video data, a second input, including a selection of options for processing the first input into an audiovisual output, and an output display that displays an audiovisual output to the user. The method also includes providing a content transformation system. The content transformation system includes a speech transcription engine that processes speech from the first input into a text transcription, a content generator that processes the first input and the second input and generates a speech transcript and summary in a target language, a speech generation engine that converts the speech transcript into an audio output in the target language, a speech cloning engine that converts the audio output into a cloned audio output in the target language, a video generator that generates a video output of an avatar of the user speaking the cloned audio output in the target language, and/or an output generator that generates illustrative images and text in the target language based on the first input, the second input, and the speech transcript. The output generator also synchronizes the summary, the illustrative images, and the text with the video output into a single audiovisual output that is output to the user interface.

One or more implementations provide a system for creating and managing multimedia profiles. The system includes a user interface that receives user input from a user, the user input including a profile name, a preferred language, and an audio video upload; a processor that processes the audio video upload by separating an audio component and a video component and transcribes the audio component into a text transcript; a database for storing the audio video upload, video component, audio component, and text transcript; a profile generator that generates an audio and video profile of the user; and a profile management module that displays a list of profiles and allows deletion, creation, and/or editing of the multimedia profiles. The audio and video profile includes a cloned avatar based on the video component and a cloned voice profile based on the audio component.

One or more implementations provide a method for creating and presenting multimedia content. The method includes receiving a user upload including text input, visual input, and audio input from a user; generating an avatar of the user based on the visual input; generating a voice profile based on the audio input; generating an audio output in the user’s voice of the text input using the voice profile; generating a video output using the avatar lip-synced to the audio output; and combining and synchronizing the audio output with the video output to generate the multimedia content.

One or more implementations provide a system for interactive chat and multimedia content. The system includes a user interface that receives input from a content viewer and a processor that processes the input and generates a response. The user interface further displays the response as chat and/or audio video content.

One or more implementations relate to one or more methods that include one or more of: accessing source content and stored user data, the stored user data including voice characteristic data and appearance data; generating a speech transcript derived from the source content; generating speech audio content based on the speech transcript and the voice characteristic data, the speech audio content including a voicing of the speech transcript in accordance with the voice characteristic data; generating video content including an avatar synchronized with the speech audio content, the avatar having an appearance based on the appearance data; combining the speech audio content and the video content to generate a synchronized audiovisual output; and/or presenting the synchronized audiovisual output.

One or more implementations include one or more non-transitory computer-readable media including instructions that cause performance of one or more of the methods when executed by one or more hardware processors. One or more implementations include a system having one or more hardware processors; an input interface; an output interface; a content transformation subsystem; a datastore; and instructions stored on the one or more non-transitory computer-readable media which, when executed by the one or more hardware processors, cause the system to perform one or more of the methods.

One or more implementations improve multimedia content generation by integrating a multimodal, end-to-end transformation pipeline that operates on structured document inputs (e.g., pages or slide images) to generate synchronized audiovisual outputs and interactive metadata in a unified workflow. By converting documents into page-level image representations and processing them through an instruction-tuned multimodal model to generate speaker notes, summaries, salient phrases, and quizzes in a structured format [e.g., JavaScript object notation (JSON)], the system reduces redundant processing steps, eliminates the need for multiple independent model invocations, and minimizes intermediate data transfer between disparate tools. The use of precomputed and persisted metadata (e.g., transcripts, summaries, and key phrases) further helps the AI tutor subsystem to respond to user queries without recomputing context, thereby reducing processor load, memory usage, and response latency during real-time interaction. Additionally, techniques such as neural-network-based video chunking into semantically coherent segments and synchronized alignment of cloned audio, lip-synced avatar video, and highlighted visual elements improve rendering efficiency, reduce recomputation during playback, and facilitate more efficient streaming and/or navigation of content while reducing temporal misalignment between independently generated modalities. Collectively, these technical features improve system determinism, reduce computational overhead and network bandwidth consumption, and enhance scalability and responsiveness relative to conventional content generation systems lacking these features.

Devices, systems, and methods for generating cloned audio and video representations of a user are described in U.S. Provisional Patent Application No. 63/727,885, titled “System and Method for Semi-Supervised Prompt Based Speech Transformation with Users Natural Voice Preservation,” filed on Dec. 4, 2024, which is incorporated herein by reference in its entirety.

Further aspects and embodiments are provided in the foregoing drawings, detailed description, and claims. The Figures(FIGS.) and the following description describe certain embodiments by way of illustration only. One skilled in the art will readily recognize from the following description that alternative implementations of the structures and methods illustrated herein may be employed without departing from the principles described herein. Reference will now be made to several implementations, examples of which are illustrated in the accompanying figures. Wherever practicable, similar or like reference numbers may be used in the figures and may indicate similar or like functionality.

The multimedia creation system will become better understood through a review of the following detailed description in conjunction with the figures. The detailed description and figures provide examples of the various embodiments of the system. Many variations are contemplated for different applications and design considerations; however, for the sake of brevity and clarity, the contemplated variations may not be individually described in the following detailed description. Those skilled in the art will understand how the disclosed examples may be varied, modified, and altered and not depart in substance from the scope of the examples described herein.

### Summary of Terms

The following summary of terms is provided for ease of reference. The summaries associated with the terms are not lexicographic definitions, and the summary descriptions may include various non-limiting examples. The full meaning of such terms should be interpreted in accordance with their ordinary and customary meaning as understood by a person of ordinary skill in the art, in view of the specification as a whole and consistent with applicable legal principles of claim construction.

As used herein, “and/or” includes any and all combinations of one or more of the associated listed items.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein “data” refers to information. Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

As used herein, the term “data connection” and similar terms are meant to refer to any wired or wireless means of transmitting analog or digital data and a data connection may refer to a connection within a multimedia content creation system or with devices outside the multimedia content creation system.

As used herein “communication device” refers to any device capable of sending and/or receiving data. The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas. The communication device may include, for example, a networking chip, one or more antennas, and/or one or more communication ports.

As used herein, “input” is meant to refer to any information or data in any format from a user to the system.

As used herein, “interpretation” is meant to refer to determining an intent expressed in a verbal input, transcription, and/or text input. Interpretation does not mean converting an input into a language other than that of the input. As used herein, “translation” is meant to refer to converting an audio or text in a first language into a second language or a different dialect of the first language.

As used herein, “speech transformation” is meant to refer to conversion of a verbal input into a verbal output where the input is changed in one or more ways (e.g., summarized, interpreted, translated, expanded, improved).

As used herein, “content transformation” is meant to refer to conversion of any input into written, verbal, and visual output where the input is changed in one or more ways (e.g., summarized, interpreted, translated, expanded, improved) for use in educational presentations.

### 2. USER PROFILE DATA GENERATION FOR MULTIMEDIA CONTENT CREATION

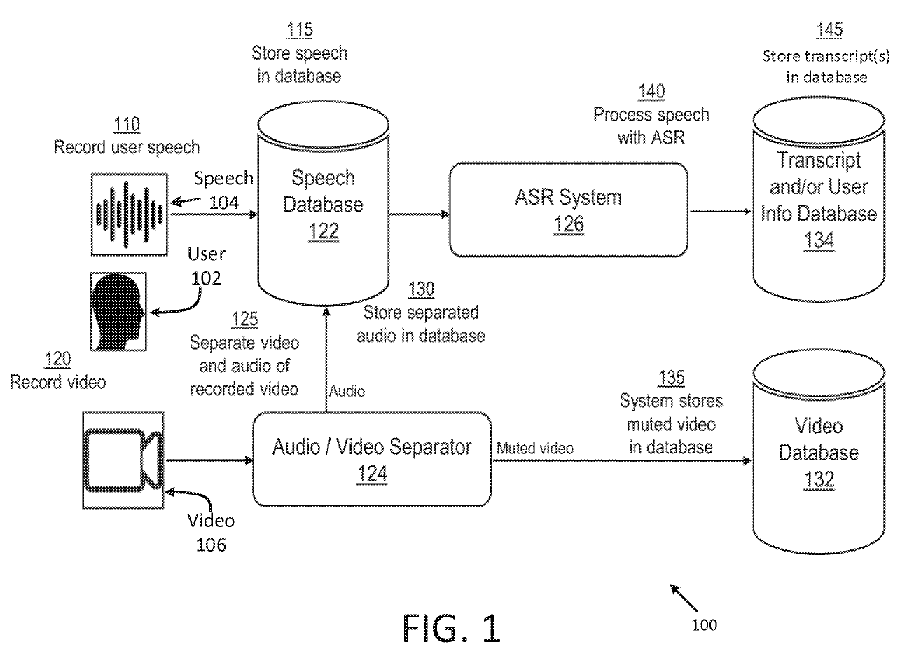

FIG. 1 illustrates a user profile data generation and storage subsystem of a multimedia content creation system. In some implementations, a user profile data generation and storage subsystem 100 is configured to perform a method for creating a multilingual audio/video user profile and/or managing such profiles, including creation, modification, and deletion. Operations described with respect to FIG. 1 may be performed by one or more processors of the user profile data generation and storage subsystem 100 and/or other components of the multimedia content creation system. One or more operations and/or components illustrated in FIG. 1 may be modified, rearranged, combined, or omitted, distributed across multiple computing systems, implemented using cloud-based, remote, or third-party services, coupled via a network, or a combination thereof. Accordingly, the particular configuration and sequence of operations shown in FIG. 1 are illustrative and not limiting. Functionality described as being performed by a particular component may be performed by any other component or distributed across multiple components.

As shown in FIG. 1, and by reference number 110, the subsystem 100 records user speech 104. Speech 104 from a user 102 may be recorded using one or more audio capture devices, such as a microphone of a client device. The user speech 104 may include a spoken introduction or other user-provided audio in a selected language as part of a user profile creation process and may be captured as digital audio data [e.g., waveform audio format (WAV), moving picture experts group (MPEG) 1 or MPEG 2 Audio Layer III (MP3), or another audio format] for subsequent processing.

As shown in FIG. 1, and by reference number 115, the subsystem 100 stores the speech 104 in a speech database 122. The speech database 122 may be implemented using one or more storage devices, such as cloud-based object storage or non-relational databases, and may associate the stored speech 104 with a corresponding user profile identifier for later retrieval and use.

As shown in FIG. 1, and by reference number 120, the subsystem 100 records a video 106. For example, the subsystem 100 records video 106 of the user 102, which may be a front-facing video, using one or more image capture devices, such as a camera of the client device. The video 106 may capture visual data of the user 102 speaking in a particular language and may be recorded contemporaneously with or independently from the speech 104.

As shown in FIG. 1, and by reference number 125, the subsystem 100 separates video and audio of the recorded video 106. For example, the subsystem 100 processes the video 106 using an audio/video separator 124 to extract an audio component and a video component from the video 106. The separation may be performed using media processing software or codecs to produce a speech-containing audio stream and a corresponding visual stream. In some implementations, the audio/video separator 124 is hosted on an audio/video separator elastic cloud compute (EC2) instance.

As shown in FIG. 1, and by reference number 130, the subsystem 100 stores the separated audio component in the speech database 122. In some implementations, the subsystem 100 links the stored separated audio component with the previously recorded speech 104 and/or with associated user metadata.

As shown in FIG. 1, and by reference number 135, the subsystem 100 stores a muted video in a video database 132. For example, the subsystem 100 stores the extracted visual portion of the video 106, which may include a muted video stream, in a database 132, which may include one or more front-facing muted videos. The muted video may preserve facial movements, expressions, and/or head pose data, of the user 102, for use in generating an avatar or a reconstructed visual representation, such as a photorealistic clone or other visual representation, of the user 102.

As shown in FIG. 1, and by reference number 140, the subsystem 100 processes speech with automated speech recognition (ASR). For example, the subsystem 100 processes the speech 104 and/or the extracted video-audio of the video 106 using an ASR system 126. In various implementations, the ASR system 126 may be monolingual or multilingual and may be used to process the speech 104 and/or the separated audio. The ASR system 126 may include one or more multilingual speech recognition models configured to convert speech in different languages into corresponding text transcripts in the same or other languages. In some implementations, the ASR system 126 is hosted on an ASR EC2 instance.

As shown in FIG. 1, and by reference number 145, the subsystem 100 stores one or more user transcripts in a database 134. For example, the subsystem 100 stores one or more transcripts generated by the ASR system 126 in a database 134 that contains one or more transcripts and/or user information. The stored transcript(s) may include text indexed by and/or associated with corresponding audio and video data and may be used to derive user-specific voice characteristic data and/or other profile attributes for subsequent multimedia content generation.

In the example, the databases 122, 132, and 134 are storage structures accessible by the subsystem 100 and/or other components of the multimedia content creation system and are configured to store data associated with the subsystem 100 and/or other components of the multimedia content creation system. In one or more implementations, database 122 stores speech data and audio-related information, database 132 stores front-facing muted video data, and database 134 stores text transcripts and/or user information. The databases 122, 132, and 134 may be implemented using one or more memory devices, such as non-volatile memory for persistent storage and/or volatile memory and may be organized to support various data structures.

In one or more implementations, the databases 122, 132, and 134 include one or more storage units or devices, such as file systems, databases, collections of tables, or other storage mechanisms for storing data. Multiple storage units or devices may be used and may differ in type and physical location. The databases 122, 132, and 134 may be implemented on the same computing system as the subsystem 100 or on one or more separate computing systems. The databases 122, 132, and 134 may be communicatively coupled to the subsystem 100 via a direct connection or via one or more networks.

Information describing components of the subsystem 100 may be implemented across one or more components of the subsystem 100 or one or more components of the multimedia content creation system. In the example, the information is illustrated as being stored in the databases 122, 132, and 134 for clarity and explanation. In some implementations, the stored information is represented using structured data formats, such as records, tables, graphs, trees, vectors, embeddings, tensors, or matrices.

### 3. MULTIMEDIA CONTENT CREATION SYSTEM

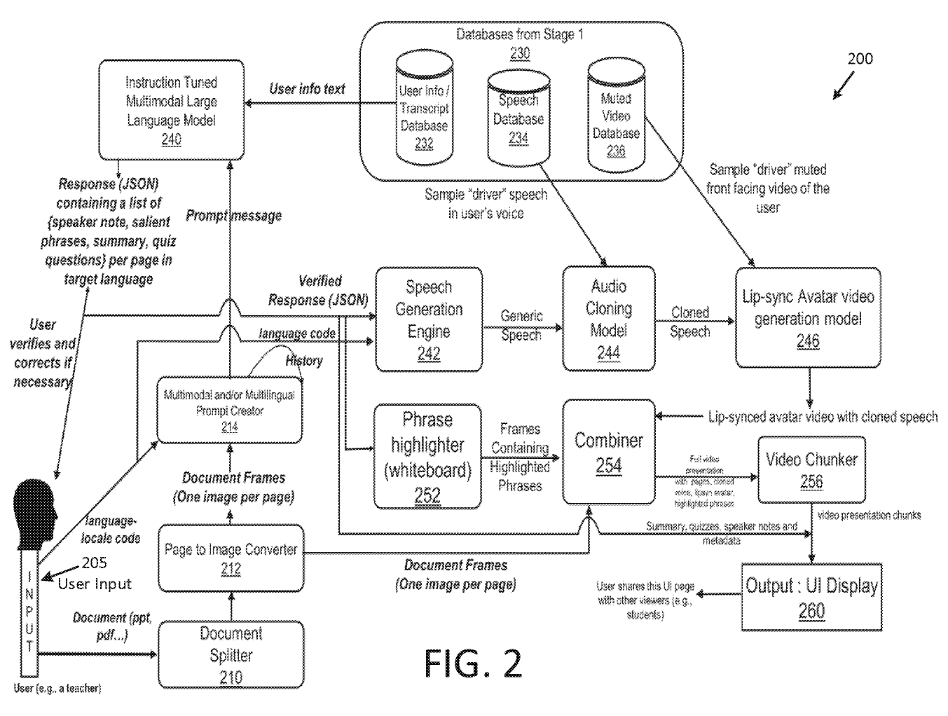

FIG. 2 illustrates a block diagram of a content creation subsystem of a multimedia content creation system. As shown in FIG. 2, a content creation subsubsystem 200 may be used to perform a method of converting one or more documents into a multimedia presentation. In some implementations, a the content creation subsubsystem 200 is a subsystem a of a multimedia content creation system. The illustrated components represent logical and functional components of the content creation subsubsystem 200 and/or components of the multimedia content creation system and are not intended to require a particular physical or software architecture. In one or more implementations, components may be combined, subdivided, distributed across multiple computing systems, implemented using cloud-based, remote, or third-party services, coupled via a network, or a combination thereof. Functionality described as being performed by a particular component may be performed by any other component or distributed across multiple components of the multimedia content creation system.

In this example, a user provides user input 205, (e.g. a file, document, or other input) in the form of one or more documents, which may include text, images, video, and/or audio (e.g., PowerPoint, Adobe, MS Word). The user, who may have a previously created profile, uploads the document(s) to the system. In various implementations, the user may indicate a source language, or the source language may be automatically detected. The user may select a language for the multimedia presentation output. The subsubsystem 200 may process the document(s) to validate the format and verify file integrity. In some implementations, the subsystem 200 may be adapted for educational purposes. In such implementations, the document input may be educational (e.g., in the form of text, presentation slides, etc.)

In the example of FIG. 2, the multimedia content creation subsystem 200 includes a document splitter 210, a page to image converter 212, a multimodal and/or multilingual prompt creator 214, one or more databases 230, an instruction tuned multimodal large language model (LLM) 240, a speech generation engine 242, an audio cloning module 244, a lip-sync avatar video generation module 246, a phrase highlighter (whiteboard) 252, a combiner 254, a video chunker 256, and an output user interface (UI) display 260. In some implementations, the system receives user input 205 including a document and a language or locale code, retrieves profile-related data from the databases 230, and generates a multilingual audiovisual presentation for display and sharing.

In the example of FIG. 2, the document splitter 210 is configured to receive a document from the user input 205 and divide the document into individual pages or slides. The document may include, for example, a presentation file, portable document format (PDF), word processing document, or other multimedia file. The document splitter 210 may further convert each page or slide into a structured representation suitable for downstream processing and preserve associations between pages or slides and corresponding metadata. In some implementations, the system may include an image recognition component configured to analyze content within document images.

The page to image converter 212 is configured to convert each page or slide into a corresponding document frame, such as one image per page. The page to image converter 212 may generate rasterized images [e.g., portable network graphics (PNG) or joint photographic experts group (JPEG)] that preserve layout, text, and graphical elements of the original page or slide. In some implementations, the converter ensures text clarity and visual fidelity to support downstream multimodal processing, and each generated image may be converted into a byte representation, such as base64-encoded image data.

The multimodal and/or multilingual prompt creator 214 is configured to generate structured prompt messages for each document frame. The prompt creator 214 may receive document frame image data, a user-selected language or locale code, metadata, and prompt-response history. In some implementations, the prompt creator 214 applies predefined prompt templates to combine these inputs into a multimodal prompt message. The prompt may include encoded image data, language identifiers, contextual history, and instructions to generate speaker notes, salient phrases, summaries, quizzes, illustrative content, and additional metadata for each page or slide in a selected target language and dialect. The prompt may be generated using programmatic techniques, such as string manipulation or prompt orchestration libraries. In some implementations, the system processes one or more document frames independently. For one or more pages or slides, the corresponding image representation is converted into a byte format, such as a base64-encoded representation, prior to prompt generation. The prompt creator applies a predefined prompt template to the byte-encoded image, a language or locale identifier, and prompt-response history to generate a structured prompt message for the one or more pages. The predefined prompt template functions as an instruction engine that defines the structure and content of outputs to be generated, such as speaker notes, salient phrases, summaries, quizzes, introductions, conclusions, and/or associated metadata for the corresponding one or more pages.

The one or more databases 230 include a user info/transcript database 232, a speech database 234, and a muted video database 236. These databases may correspond to data generated in a prior stage and may store user-specific data and intermediate outputs used throughout the multimedia content generation pipeline.

The user info/transcript database 232 is configured to store user information and transcript-related data. Such data may include structured outputs generated by the language model 240, such as speaker notes, summaries, salient phrases, quizzes, illustrative content, metadata, and prompt-response history. In some implementations, the structured outputs are stored in a machine-readable format, such as JSON, and may be associated with corresponding document pages. The system may present generated structured outputs to a user for verification, and the user may correct errors or modify the content prior to storing a verified response.

The speech database 234 is configured to store speech-related data associated with one or more users. The speech database 234 may store user-recorded speech samples, sample “driver” speech in the user’s voice, generic speech generated by text-to-speech processing, and cloned speech. In some implementations, the stored speech data is used to condition voice cloning processes.

The muted video database 236 is configured to store video data associated with user profiles, such as front-facing muted video recordings. The stored video data may capture facial expressions, head movement, and other visual characteristics used as driver inputs for avatar generation and lip synchronization.

The instruction tuned multimodal large language model (LLM) 240 is configured to receive prompt messages from the prompt creator 214 and user information from the user info/transcript database 232 and generate structured outputs. The LLM 240 may include a fine-tuned multimodal and multilingual model capable of processing image inputs and textual prompts. The structured outputs may include speaker notes for each page, salient phrases, summaries, illustrative images (e.g., pictures, charts, graphs, or text-based visuals), quizzes, introductions, conclusions, and/or metadata, generated in a selected language and dialect. The outputs may be formatted as structured data, such as JSON, and may be presented to a user for verification and correction prior to further processing. In some implementations, the instruction tuned multimodal large language model generates structured outputs for one or more document frames, such that one or more pages are associated with corresponding structured responses. The structured responses may include speaker notes, salient phrases, summaries, quizzes, and illustrative content generated by the model. The illustrative content may include generated visual elements such as diagrams, charts, graphical annotations, or textual overlays that are distinct from the original document images. The structured outputs may be formatted in a machine-readable representation, such as JSON, and may be stored for downstream processing.

The speech generation engine 242 is configured to receive verified structured outputs and generate corresponding speech audio. The speech generation engine 242 may utilize a text-to-speech (TTS) system to convert speaker notes into synthetic speech in the selected language and dialect. In some implementations, the generated speech is initially produced using a generic voice. In some implementations, the speaker notes are translated into a selected output language and dialect prior to speech generation, with preservation of domain-specific terminology, technical phrases, and contextual meaning. The speech generation process may include a two-stage pipeline in which a text-to-speech system first generates generic speech in the selected language, and the generated speech is subsequently processed by the audio cloning module to produce cloned speech that reflects user-specific voice characteristics.

The audio cloning module 244 is configured to receive the generated generic speech and modify the speech using stored user speech samples from the speech database 234. The audio cloning module 244 may generate cloned speech that replicates the user’s voice characteristics, such as pitch, tone, intonation, cadence, and speaking style.

The lip-sync avatar video generation module 246 is configured to receive cloned speech and sample front-facing muted video from the muted video database 236 and generate a lip-synced avatar video. The generated avatar video may depict the user speaking in temporal synchronization with the cloned speech, based on facial movement and expression data derived from the stored video. In various implementations, an avatar may be a photorealistic clone, a stylized model, an animated entity, a generic representation of the user, or another visual representation of the user.

The phrase highlighter (whiteboard) 252 is configured to receive document frames and structured outputs from the LLM 240. The phrase highlighter 252 may extract salient phrases and generate visual frames in which the phrases are emphasized relative to corresponding document images. The emphasized representations may include highlighted text, bounding boxes, callouts, or whiteboard-style annotations. The generated frames may be aligned with portions of the speech transcript and synchronized with timestamps corresponding to when the phrases are spoken or explained. In some implementations, the phrase highlighter aligns salient phrases with corresponding portions of a speech transcript in addition to aligning the phrases with temporal timestamps. The alignment may be based on mapping between generated speaker notes and transcript segments, such that highlighted phrases are displayed when corresponding content is spoken and explained in the audiovisual presentation.

The combiner 254 is configured to receive multiple content streams and combine them into a unified audiovisual presentation. The combiner 254 may receive document frames, frames containing highlighted phrases, cloned speech audio, lip-synced avatar video, summaries, quizzes, speaker notes, and metadata. The combiner 254 may temporally align and synchronize these elements, including frame-by-frame synchronization, to generate a full multimedia presentation combining all content elements. In some implementations, the combiner generates a full audiovisual presentation prior to segmentation. The full audiovisual presentation may include a temporally aligned combination of document frames, highlighted phrase frames, cloned speech, avatar video, summaries, quizzes, and associated metadata, forming a complete multimedia output prior to division into segments.

The video chunker 256 is configured to segment the combined audiovisual presentation into multiple segments or modules. The segmentation may be based on semantic boundaries identified using a neural-network-based content splitter, timestamps, predefined durations, or user-specified split points. Each segment may correspond to a subtopic and may be associated with summaries, quizzes, speaker notes, and metadata. The video chunker 256 may generate metadata to support navigation and organize the segments for sequential playback. In some implementations, segmentation is performed using a neural-network-based content splitter configured to identify semantic boundaries within the presentation. The segmentation may further be implemented using video processing tools, such as fast forward (FF) MPEG (ffMPEG), to perform splitting and encoding of video segments.

The output user interface (UI) display 260 is configured to present the generated audiovisual presentation to a user. The UI display 260 may display segmented video content along with associated summaries, quizzes, and metadata and may allow interaction with the content by a viewer or other user. The UI display 260 may further enable sharing of the generated presentation, such as by providing a network-accessible interface or by generating a uniform resource locator (URL) that allows the content to be accessed by additional users.

In some implementations, the multimedia content creation system produces an interactive audiovisual presentation, such as an educational presentation, in which users interact with generated content including quizzes, summaries, and segmented modules. The UI display 260 may support dynamic navigation, user responses to assessment content, and adaptive presentation of information based on user interaction. The final multimedia output may be stored on a remote server and may be accessible to a viewer on a remote server (e.g., a cloud or user-hosted server). The system may include software for storing the output on a chosen server and/or for creating a URL to the content.

The UI display 260 refers to hardware and/or software configured to facilitate presentation of output from the subsystem 200 to a user and/or operator. For example, the UI display 260 may include components such as a display device and rendering modules configured to present audiovisual content, text, graphics, and other generated outputs.

In one or more implementations, the UI display 260 includes software that renders user interface elements associated with output presentation. The UI display 260 may present generated audiovisual outputs, segmented video modules, summaries, quizzes, transcripts, chat responses, and other content produced by the subsystem 200. In some implementations, the UI display 260 includes communication components, such as a Wi-Fi or Bluetooth interface, that facilitate delivery or streaming of output content to external devices.

Examples of output interfaces provided by the UI display 260 include a graphical user interface (GUI), a video playback interface, a dashboard interface, and a voice output interface. These interfaces may be implemented directly within the subsystem 200 or accessed via a connected device, such as a mobile device or personal computer, executing an application that presents generated content. Examples of output elements include video frames, rendered text, highlighted phrases, charts, progress indicators, notifications, and structured content displays.

### 4. INTERACTIVE TUTORIAL

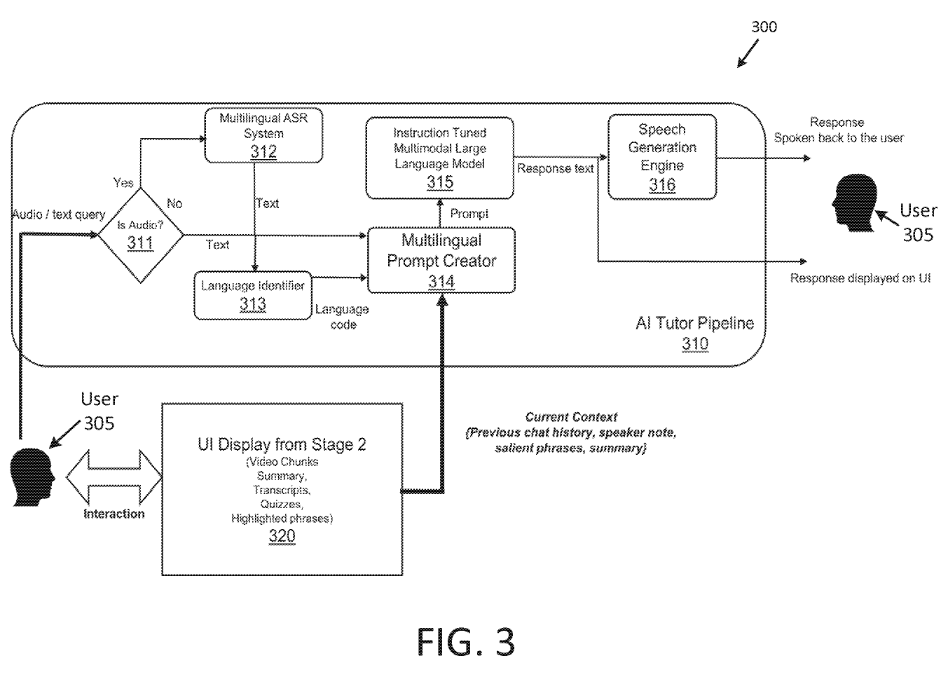

FIG. 3 illustrates an interactive tutorial subsystem of the multimedia content creation system. FIG. 3 illustrates a method of creating an artificial intelligence (AI) tutorial using an interactive tutorial subsystem 300 to provide real-time responses to viewers of an interactive educational audiovisual presentation. The illustrated components represent logical and functional components of an interactive tutorial subsystem 300 and are not intended to require a particular physical or software architecture. In one or more implementations, components may be combined, subdivided, distributed across multiple computing systems, implemented using cloud-based, remote, or third-party services, coupled via a network, or a combination thereof. Functionality described as being performed by a particular component may be performed by any other component or distributed across multiple components.

In the example of FIG. 3, the interactive tutorial subsystem 300 includes an AI tutor pipeline 310 accessed by a user 305, and the interactive tutorial subsystem 300 includes a UI display 320. The AI tutor pipeline 310 is configured to provide real-time interactive responses to user queries in the context of previously generated multimedia content. A real-time response may refer to a response that occurs during an active session of a viewer using the interactive tutorial subsystem 300. In this context, real-time means that the viewer receives responses within a latency threshold, such as a typical conversation latency threshold. A typical conversational latency threshold may be about 200-500ms, or less than a second, or a greater or smaller threshold. Some implementations may use a response time latency threshold to constrain response time so that the AI tutor pipeline 310 provides responses within a conversational latency threshold. For example, some implementations may configure an instruction tuned multimodal large language model to generate a response within a threshold amount of time.

The AI tutor pipeline 310 includes a decision block 311, a multilingual automatic speech recognition (ASR) system 312, a language identifier 313, a multilingual prompt creator 314, an instruction tuned multimodal large language model (LLM) 315, and a speech generation engine 316. In some implementations, the subsystem operates in conjunction with content generated in prior stages, such as video chunks, summaries, transcripts, quizzes, and highlighted phrases, which are displayed via the UI display 320 and serve as contextual input to the AI tutor pipeline.

The decision block 311 is configured to determine whether an input received from the user 305 includes audio, text, or a combination thereof. The user input may be received through an interactive interface, such as a chat panel, and may include spoken queries or typed text queries. If the input includes audio, the decision block 311 directs the audio input to the multilingual ASR system 312 for transcription. If the input does not include audio, the input may be provided directly to downstream components in text form.

The multilingual ASR system 312 is configured to process audio input received from the decision block 311 and convert the audio into a corresponding text transcript. The ASR system 312 may include one or more multilingual speech recognition models capable of processing speech in multiple languages and dialects. The generated text transcript may be provided to the language identifier 313 and may optionally be displayed to the user via the UI display 320.

The language identifier 313 is configured to determine the language of the input text, whether the text originates from direct user input or from ASR transcription. The language identifier 313 may utilize one or more language detection libraries or models, such as statistical or neural-network-based classifiers, to assign a language code to the input. The text input and corresponding language code are then provided to the multilingual prompt creator 314.

If the input is text (either originally provided as text or generated by the ASR system 312), the multilingual prompt creator 314 is configured to generate a structured prompt for processing by the instruction tuned multimodal LLM 315. The multilingual prompt creator 314 may incorporate the user input, the detected language code, prior chat history, and contextual information from the UI display 320, such as speaker notes, salient phrases, summaries, and other presentation content, to construct a context-aware prompt. In some implementations, the prompt creator 314 applies predefined prompt templates and may structure the prompt using machine-readable formats, such as JSON.

The multilingual prompt creator 314 transmits the generated prompt to the instruction tuned multimodal LLM 315. The instruction tuned multimodal LLM 315 is configured to process the prompt and generate a response in the appropriate language and dialect. The LLM 315 may include a fine-tuned multilingual model capable of generating context-aware responses based on the presentation content and user input. In some implementations, the LLM 315 produces a text-based response that is aligned with the subject matter of the presentation and the user’s query. The response text is transmitted to the speech generation engine 316.

The speech generation engine 316 is configured to convert the response text generated by the LLM 315 into speech output. The speech generation engine 316 may utilize a text-to-speech (TTS) system to generate synthetic speech in the detected or selected language. The generated speech may initially be produced using a generic voice and may optionally be modified to correspond to a content provider’s cloned voice. The speech generation engine 316 outputs the spoken response to the user 305 and may also provide a visual representation of the response text via the UI display 320.

In some implementations, the interactive tutorial subsystem 300 provides a fully interactive experience in which users engage with multimedia content through a conversational interface. The UI display 320 may include a chat feature that allows users to submit queries and view responses in real time. The subsystem may validate user input using a neural network-based validation model to determine whether the input is relevant to the presentation content. If the input is determined to be unrelated, the system may generate an error message. Otherwise, the system generates a context-aware response based on the presentation content and prior interactions.

In some implementations, the interactive tutorial subsystem provides a fully interactive experience via a viewer input receiver, such as a chat interface, capable of receiving both typed and spoken input from a viewer. When the viewer provides spoken input, a speech-to-text (STT) or transcription engine converts the speech into a corresponding text representation, which may optionally be displayed within a chat panel of the user interface. In some implementations, the transcription engine used for viewer input may be distinct from, or the same as, the speech processing components used during profile creation and content generation.

The text version of the viewer’s input, whether originally provided as text or generated via transcription, is processed using a language detection component to identify the language of the input. A corresponding language code is assigned, and the text and language code are used for downstream processing. The language detection component may be implemented using one or more language detection libraries or models, such as statistical or neural-network-based systems. In some implementations, the system includes a validation module, such as a neural network-based language model, configured to determine whether the viewer input is relevant to the content of the presentation. If the viewer input is determined to be unrelated, the system may generate an error message. Otherwise, the system constructs a context-aware prompt that incorporates the viewer input along with contextual information, such as contemporaneously displayed content, prior chat history, and presentation-related data including speaker notes, salient phrases, and summaries. The prompt may be generated using predefined prompt templates and structured using machine-readable formats, such as JSON.

The constructed prompt is processed by an AI engine, such as an instruction tuned multimodal large language model (LLM), to generate a response in a target language, which may correspond to the presentation language, the viewer input language, or another selected language or dialect. The response is initially generated as text output. The text response, along with language and dialect information, is provided to a text-to-speech (TTS) system configured to generate corresponding synthetic speech in the target language. The synthetic speech may initially be generated using a generic voice and may optionally be modified to correspond to a cloned voice associated with a content provider. The text version of the response may also be displayed within the chat interface, allowing the viewer to read and listen to the response.

In some implementations, the disclosed systems and methods are implemented across one or more computing devices in a distributed computing environment. The various components may communicate via one or more communication networks to exchange data and coordinate processing of user input and generated outputs.

In an example use case, a content creator, such as a professor developing an online course, utilizes the system to generate multilingual educational content. The content creator may record lectures, course descriptions, and announcements in a native language and upload associated materials, such as lecture videos, course curriculum, presentations, and slides. The content creator may create a user profile by recording a front-facing video and speech samples, which are used to generate a voice profile and visual profile.

The system processes the uploaded materials to generate structured outputs, such as speaker notes or scripts, which may be reviewed and edited by the content creator prior to approval. Based on the approved content, the system generates video lectures in one or more languages selected by the content creator, including languages other than the original input language. The system may generate audiovisual content in which an avatar representing the content creator is overlaid and configured to speak the generated content using a cloned version of the creator’s voice. The avatar is lip-synced to the cloned speech and synchronized with visual presentation content, such as slides and highlighted phrases.

To improve usability, the generated multimedia content may be segmented into multiple video modules or chunks, such as dividing a course into multiple shorter videos. The segments may be organized into a playlist to facilitate navigation and consumption. Each segment may include automatically generated introductory and concluding portions and may be accompanied by slides containing concise summaries of the current content. In some implementations, the user interface includes an integrated AI tutor panel that enables viewers to ask questions and receive real-time responses related to the content.

In some implementations, the system further includes a monitoring interface, such as a dashboard application, that allows the content creator to review user interactions with the multimedia content. The system may track user engagement, queries, and performance on assessments. User interactions that occur in languages different from the content creator’s language may be automatically translated, enabling the content creator to analyze viewer behavior, identify areas of difficulty, and improve the content accordingly.

### 5. OPERATIONS FOR MULTIMEDIA CONTENT CREATION, PRESENTATION, AND QUERYING

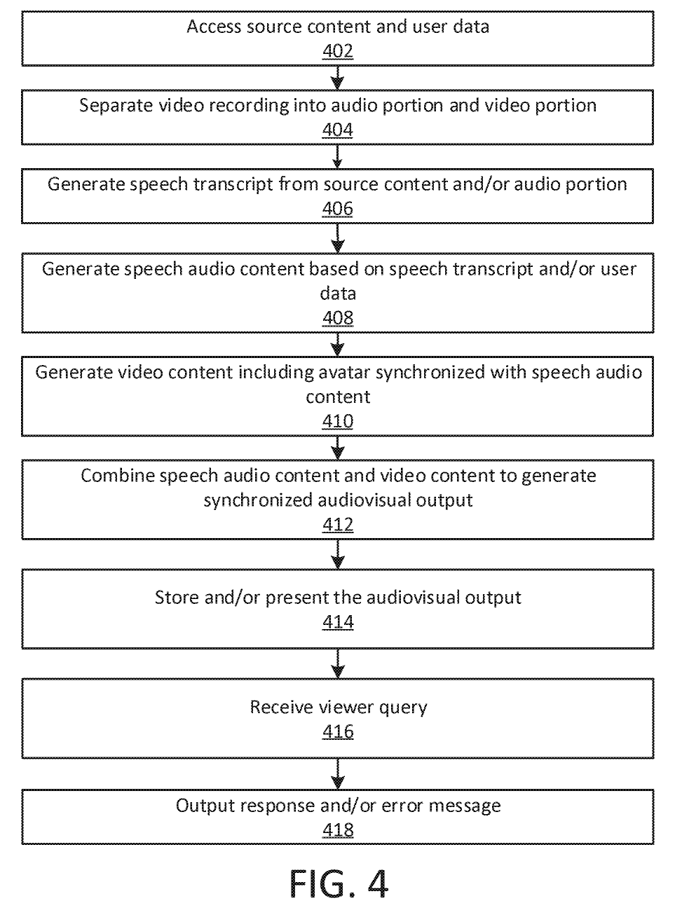

FIG. 4 illustrates a set of operations for multimedia content creation, presentation, and querying, in accordance with one or more implementations. Operations described with reference to FIG. 4 may be performed by one or more subsystems of a multimedia content creation system. One or more operations illustrated in FIG. 4 may be modified, rearranged, or omitted altogether. Accordingly, the particular sequence of operations illustrated in FIG. 4 should not be construed as limiting the scope of implementations.

The system accesses source content and user data (Operation 402). In this operation, the system retrieves input materials and stored profile information for use in downstream processing. In some implementations, the source content includes documents such as presentation slides, PDF files, or lecture materials provided via a user interface, and the user data includes stored voice samples and visual profile data retrieved from one or more databases, such as a speech database and a muted video database. For example, the system retrieves slide content and associated user profile data to establish inputs for content generation.

The system separates a video recording into an audio portion and a video portion (Operation 404). In this operation, the system processes a recorded front-facing video, or other video content, to extract distinct media streams. In some implementations, the system uses media processing software, such as FFmpeg, to isolate an audio track and a muted video stream from a recorded video file. For example, the system processes a user-recorded introduction video to generate an audio file containing speech and a corresponding video file containing facial motion without audio.

The system generates a speech transcript from source content and/or an audio portion (Operation 406). In this operation, the system converts input content into a textual representation suitable for narration. In some implementations, the system uses a multilingual automatic speech recognition system, such as a neural-network-based ASR model, to transcribe speech from an audio portion into text. In some implementations, the system generates a transcript from document content by processing document images using a multimodal language model to produce speaker notes corresponding to the content.

The system generates speech audio content based on a speech transcript and/or user data (Operation 408). In this operation, the system produces audio output corresponding to the generated transcript. In some implementations, the system uses a text-to-speech engine, such as a neural TTS model, to convert the transcript into synthetic speech in a selected language. In some implementations, the system processes the generated speech using a voice cloning model that incorporates stored user speech data, such as speech samples from a speech database, to generate speech audio reflecting user-specific voice characteristics.

The system generates video content including an avatar synchronized with speech audio content (Operation 410). In this operation, the system produces visual output representing a speaker aligned with the generated speech. In some implementations, the system uses stored front-facing video data, such as muted video frames from a user profile, to generate an avatar representation. The system synchronizes mouth movement and facial expressions of the avatar with the speech audio using a lip synchronization model.

The system combines speech audio content and video content to generate a synchronized audiovisual output (Operation 412). In this operation, the system integrates multiple media streams into a unified presentation. In some implementations, the system uses a combiner module, such as combiner 254 of FIG. 2, to align audio and video streams, along with additional visual elements such as document frames and highlighted phrases. The system performs temporal alignment, such as frame-by-frame synchronization, to produce a cohesive audiovisual output.

The system stores and/or presents the audiovisual output (Operation 414). In this operation, the system makes the generated multimedia content available for access. In some implementations, the system stores the audiovisual output in a remote storage system, such as a cloud-based object store, and provides access via a network-accessible interface, such as via a URL. In some implementations, the system presents the audiovisual output via a user interface, such as a playback interface that displays video segments and/or associated metadata.

The system receives a viewer query (Operation 416). In this operation, the system accepts input from a viewer interacting with the audiovisual content. In some implementations, the system receives the query through a chat interface capable of accepting typed input or spoken input. In some implementations, the system receives spoken input and converts the spoken input into text using a speech-to-text engine before further processing.

The system outputs a response and/or error message (Operation 418). In this operation, the system generates and delivers a response corresponding to the viewer query. In some implementations, the system processes the query using a language model to generate a text response and converts the text response into speech using a text-to-speech engine. In some implementations, the system evaluates the relevance of the query using a validation model and generates an error message when the query does not correspond to the audiovisual content. The system presents the response or error message via a viewer interface and/or provides a spoken output via an output device of a client device.

### 6. NETWORKED COMPUTING ENVIRONMENT

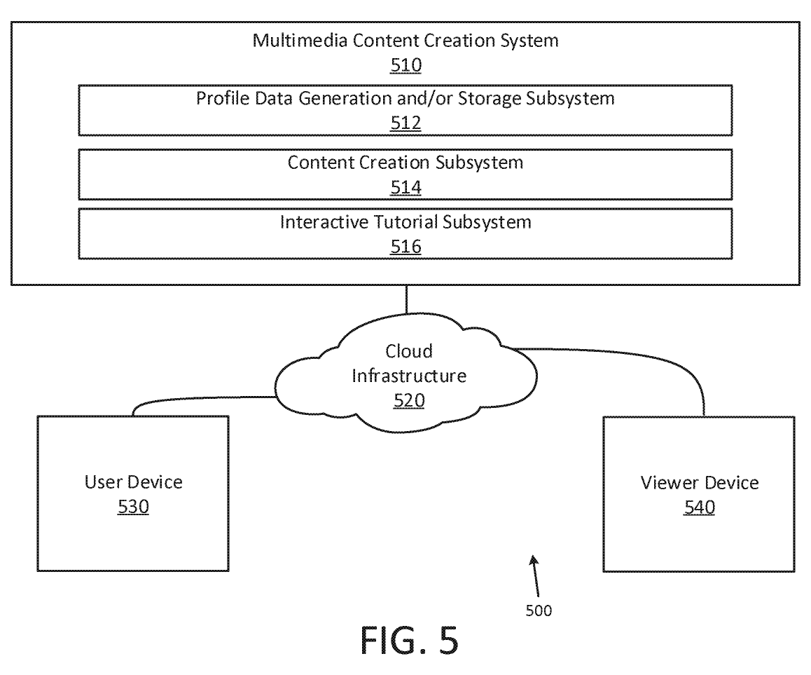

FIG. 5 illustrates a networked computing environment for deploying a multimedia content creation system. In FIG. 5, a networked computing environment 500 includes a multimedia content creation system 510, cloud infrastructure 520, a user device 530, and a viewer device 540.

The multimedia content creation system 510 includes a profile data generation and/or storage subsystem 512, a content creation subsystem 514, and an interactive tutorial subsystem 516. In one or more implementations, the profile data generation and/or storage subsystem 512 may correspond to the profile data generation and/or storage subsystem 100 of FIG. 1. In one or more implementations, the content creation subsystem 514 may correspond to the content creation subsystem 200 of FIG. 2. In one or more implementations, the interactive tutorial subsystem 516 may correspond to the interactive tutorial subsystem 300 of FIG. 3. The profile data generation and/or storage subsystem 512 is configured to generate and store user profile data, such as speech samples, video data, and text transcripts, that are used to derive voice characteristics and appearance data associated with a user. The content creation subsystem 514 is configured to process source content and user profile data to generate audiovisual outputs, such as speech audio, avatar-based video, summaries, quizzes, and segmented multimedia presentations. The interactive tutorial subsystem 516 is configured to provide an interactive interface that enables viewers to engage with generated multimedia content, such as by submitting queries and receiving responses generated by one or more language models and associated speech generation components.

The cloud infrastructure 520 includes one or more computing resources configured to support execution of the multimedia content creation system 510. In one or more implementations, the cloud infrastructure 520 includes one or more servers, virtual machines, containers, storage services, and networking components that provide scalable processing and storage capabilities. The cloud infrastructure 520 may host one or more components of the profile data generation and/or storage subsystem 512, the content creation subsystem 514, and the interactive tutorial subsystem 516. In some implementations, the cloud infrastructure 520 stores user profile data, speech data, video data, transcripts, structured outputs, and generated audiovisual content. The cloud infrastructure 520 may further provide model execution environments for machine learning components, such as multimodal large language models, speech recognition systems, and text-to-speech systems, and may facilitate communication between system components via one or more networks.

The user device 530 includes one or more computing devices configured to be used by a content creator or system operator to interact with the multimedia content creation system 510. In one or more implementations, the user device 530 includes a desktop computer, laptop computer, tablet, or mobile device. The user device 530 may be configured to provide input data to the multimedia content creation system 510, such as documents, presentation slides, audio recordings, video recordings, and user profile information. The user device 530 may further present generated outputs, such as audiovisual content, summaries, quizzes, and structured data, via a user interface. In some implementations, the user device 530 communicates with the cloud infrastructure 520 to upload input data, retrieve generated content, and manage user profiles.

The viewer device 540 includes one or more computing devices configured to present generated multimedia content to a viewer and facilitate interaction with the content. In one or more implementations, the viewer device 540 includes a desktop computer, laptop computer, tablet, smartphone, or other network-connected device. The viewer device 540 may be configured to display audiovisual outputs generated by the multimedia content creation system 510, including segmented video modules, summaries, quizzes, and highlighted content. The viewer device 540 may further provide an interface for interacting with the interactive tutorial subsystem 516, such as a chat interface that presents responses generated by a language model and associated speech output. In some implementations, the viewer device 540 communicates with the cloud infrastructure 520 to stream multimedia content and exchange data related to user interactions.

### 7. EXAMPLE VIEWER GRAPHICAL USER INTERFACE

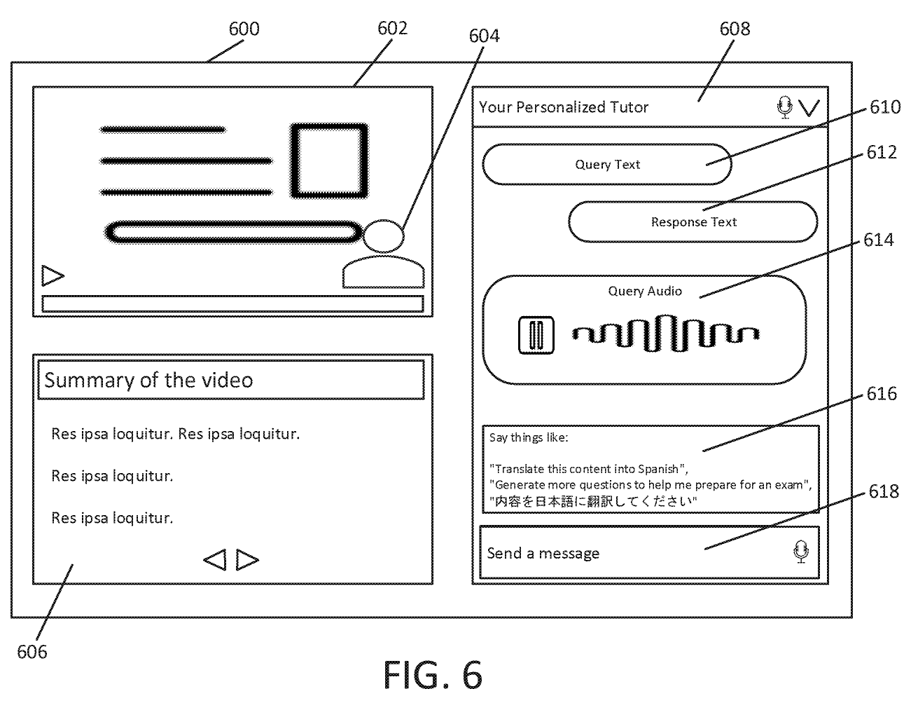

FIG. 6 illustrates an example viewer graphical user interface (GUI) for a multimedia content creation system, in accordance with one or more implementations. In FIG. 6, a viewer GUI 600 includes a video presentation interface element 602, an avatar 604, a summary of the video 606, personalized tutor section 608, query text 610, response text 612, query audio 614, message examples 616, and query input box 618.

The video presentation interface element 602 is configured to display audiovisual content generated by the multimedia content creation system. The interface element may include a playback window that presents video frames corresponding to a multimedia presentation, such as slide-based educational content synchronized with audio narration. In some implementations, the video presentation interface element 602 includes playback controls, such as play, pause, seek, or navigation controls, and may further display visual elements such as slides, highlighted phrases, or other graphical overlays associated with the presentation. Audio playback associated with the presentation may include a cloned voice of a user represented by the avatar 604.

The avatar 604 is configured to visually represent a speaker associated with the multimedia content. The avatar 604 may correspond to a generated or reconstructed visual representation of a user, such as a content creator, and may be displayed in conjunction with the video presentation interface element 602. In some implementations, the avatar 604 is synchronized with speech audio content, such that facial movements, voice, lip motion, and/or expressions correspond to the spoken narration presented within the video presentation interface element 602.

The summary of the video 606 is configured to present a textual summary of the audiovisual content displayed in the video presentation interface element 602. The summary may include key points, descriptions, or condensed information derived from the presentation content. In some implementations, the summary of the video 606 is dynamically generated based on structured outputs associated with the multimedia content and may be updated or navigable in coordination with playback of the video presentation.

The personalized tutor section 608 is configured to provide an interactive interface for engaging with an artificial intelligence (AI) tutor associated with the multimedia content. The personalized tutor section 608 may include multiple input and output elements that facilitate a viewer submitting queries and/or receiving context-aware responses. In some implementations, the personalized tutor section 608 operates in conjunction with previously generated presentation data, such as transcripts, summaries, and salient phrases, to provide responses that are relevant to the displayed content.

The query text 610 is configured to display text corresponding to a user-submitted query. The query text 610 may be generated from typed input or from transcribed audio input and may be presented within the personalized tutor section 608 as part of a conversational interface.

The response text 612 is configured to display a textual response generated by the system in response to the query text 610. The response text 612 may include explanatory content, answers to questions, or other context-aware information derived from the multimedia presentation and associated data.

The query audio 614 is configured to represent audio input provided by the user. The query audio 614 may include a visual representation of recorded audio, such as a waveform or audio indicator, and may optionally include playback controls for replaying the recorded query. In some implementations, the query audio 614 is processed using a speech recognition system to generate the query text.

The message examples 616 are configured to provide suggested queries or prompts that guide user interaction with the personalized tutor section 608. The message examples 616 may include example instructions or questions, such as requests for translation, summarization, or assessment generation, and may be presented in one or more languages to assist users in formulating queries.

The query input box 618 is configured to receive user input for submission to the personalized tutor section 608. The query input box 618 may support typed text input and, in some implementations, may include controls for initiating audio recording or voice input. The query input box 618 may further include interface elements, such as a microphone icon or send control, that enable submission of queries for processing by the system.

### 8. HARDWARE OVERVIEW

Embodiments of the above-described system may be implemented in a computing environment including a network, a server (e.g., a “backend” server) that facilitates functions of the multimedia content creation system, one or more client devices (e.g., one or more user devices and/or one or more viewer devices) that execute an application that interacts with the backend server to enable one or more of the user experiences described herein. Other embodiments may include additional or different components.

The network enables communication among the entities connected to it through one or more local-area networks and/or wide-area networks. In one embodiment, the network includes the Internet and uses standard wired and/or wireless communications technologies and/or protocols or may use custom and/or dedicated data communications technologies instead of, or in addition to, the ones described above.

The backend server includes a computing device for facilitating various functions of the multimedia content creation system described herein. The backend server may host a website accessible by a browser executing on the clients, may host a database server hosting data accessible by the backend server or one or more applications executing on the clients and/or may include an application server hosting content accessible by one or more applications executing on the clients. The backend server may perform various backend processing to facilitate tasks such as obtaining information, presenting information to the user, and/or facilitating generation of content via a generative AI technique (such as by interfacing with a third-party generative AI platform). The backend server may include an application programming interface (API) that enables it to interface with a client device, a third-party database, or another server, such as for storing, processing, and/or retrieving information such as described herein.

In one or more implementations, one or more user devices and/or client devices include a computing device that interfaces with the backend server to obtain input from users and to receive and display information received from the backend server. Such devices may include, for example, a mobile device, a tablet, a laptop computer, a desktop computer, or other computing device capable of communicating and displaying information. The client devices may execute a browser or an application that interacts with the backend server to facilitate the functions of the respective devices described herein.

Embodiments of the described computing environment and corresponding processes may be implemented by one or more computing systems. The one or more computing systems include at least one processor and a non-transitory computer-readable storage medium storing instructions executable by the at least one processor for carrying out the processes and functions described herein. The computing system may include distributed network-based computing systems in which functions described herein are not necessarily executed on a single physical device but may be distributed across multiple devices. For example, some implementations may utilize cloud processing and storage technologies, virtual machines, or other technologies.

Some aspects of the techniques described herein are implemented by one or more computing devices that may be hard-wired to perform the techniques, that may include digital electronic devices such as one or more application-specific integrated circuits (ASICs), field programmable gate arrays (FPGAs), or network processing units (NPUs) that are persistently programmed to perform the techniques, or that may include one or more general purpose hardware processors programmed to perform the techniques pursuant to program instructions in firmware, memory, other storage, or a combination. Such computing devices may also combine custom hard-wired logic, ASICs, FPGAs, or NPUs with custom programming to accomplish the techniques. In some implementations, the system may be coupled to one or more external computing devices that may provide various control or command functions, such as, for example, desktop computer systems, portable computer systems, handheld devices, networking devices, or any other device that incorporates hard-wired and/or program logic to implement the techniques.

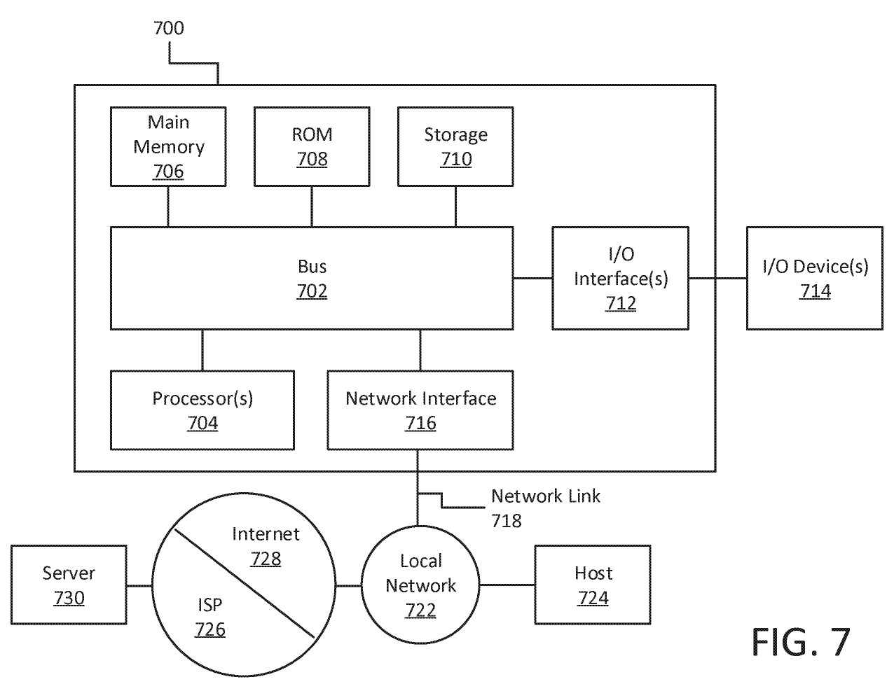

For example, FIG. 7 is a block diagram that illustrates a computer system 700 upon which one or more aspects of the disclosure may be implemented. For example, one or more client devices include one or more aspects of the example computer system 700. In FIG. 7, computer system 700 includes a bus 702 or other communication mechanism for communicating information, and a hardware processor 704 coupled with bus 702 for processing information. Hardware processor 704 may be, for example, a general-purpose microprocessor.

Computer system 700 also includes a main memory 706, such as a random-access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk, optical disk, or a solid-state drive (SSD) is provided and coupled to bus 702 for storing information and instructions.

In one or more implementations, computer system 700 may be coupled via bus 702 to one or more input and/or output (I/O) device interfaces 712 that allow for the connection of various I/O devices 714 (e.g., keyboards, displays, mouse devices, pen input, etc.) to the computer system 700.

Computer system 700 may implement the techniques described herein using customized hard-wired logic, one or more ASICs or FPGAs, firmware, and/or program logic which in combination with the computer system causes or programs computer system 700 to be a special-purpose machine. According to one implementation, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative implementations, hard-wired circuitry may be used in place of or in combination with software instructions.

Storage media associated with the described system may include any non-transitory media that store data and/or instructions that cause a machine to operate in a specific fashion. Such storage media may include non-volatile media and/or volatile media. Non-volatile media includes, for example, optical or magnetic disks, such as storage device 710. Volatile media includes dynamic memory, such as main memory 706. Common forms of storage media include, for example, a hard disk, solid state drive, optical data storage medium, a random-access memory (RAM), a programmable read-only memory (PROM), and erasable programmable read-only memory (EPROM), a FLASH-EPROM, non-volatile random-access memory (NVRAM), any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire, and fiber optics, including the wires of bus 702. Transmission media can also take the form of acoustic or light waves, such as those generated during radio-wave and infrared data communications.

Various forms of media may be involved in carrying one or more sequences of one or more instructions to processor 704 for execution. For example, the instructions may initially be carried on a storage medium of a remote computer. The remote computer can load the instructions into its dynamic memory and send the instructions over a network. Bus 702 carries the data to main memory 706, from which processor 704 retrieves and executes the instructions. The instructions received by main memory 706 may optionally be stored on storage device 710 either before or after execution by processor 704.

In one or more implementations, computer system 700 also includes a network interface 716 coupled to bus 702. This may enable the described system to connect to an external local device (such as a mobile device or personal computer) and/or to one or more remote servers that may support various operations of the described system. Network interface 716 provides a two-way data communication coupling to a network link 718 that is connected to a local network 722. For example, network interface 716 may include a local area network (LAN) interface to provide a data communication connection to a compatible LAN. Wireless links may also be implemented. In implementations, network interface 716 sends and/or receives electrical, electromagnetic, and/or optical signals that carry digital data streams representing various types of information. In one or more implementations the network interface 716 may be used to load configuration parameters and/or to update firmware associated with one or more controllers or microcontrollers deployed by the system.

Network link 718 typically provides data communication through one or more networks to other data devices. For example, network link 718 may provide a connection through local network 722 to a host computer 724 or to data equipment operated by an Internet Service Provider (ISP) 726. ISP 726 in turn provides data communication services through the worldwide packet data communication network (e.g., the Internet) 728. Local network 722 and/or Internet 728 use electrical, electromagnetic, and/or optical signals that carry digital data streams. The signals through various networks and the signals on network link 718 and through network interface 716, which carry the digital data to and from computer system 700, are example forms of transmission media.

Computer system 700 can send messages and receive data, including program code, through the network(s), network link 718 and network interface 716. In the Internet example, a server 730 might transmit a requested code for an application program through Internet 728, ISP 726, local network 722 and network interface 716. The received code may be executed by processor 704 as it is received, and/or stored in storage device 710, or other non-volatile storage for later execution.

### 9. EXAMPLE ASPECTS

One or more implementations of the multimedia content creation system and/or one or more related methods may include one or more of the following aspects:

Aspect 1: A system for creating audiovisual content, including: a user interface, including: an input receiver that receives: a first input from a user, including textual data, and a second input, including selection of options for processing the first input into an audiovisual output; and an output display that displays the audiovisual output to the user; and a content transformation system, including: a speech transcription engine that processes speech from the first input into a text transcription; a content generator that processes the first input and the second input and generates a speech transcript and summary in a target language; a speech generation engine that converts the speech transcript into an audio output in the target language; a speech cloning engine that converts the audio output into a cloned audio output in the target language; a video generator that generates a video output of an avatar of the user speaking the cloned audio output in the target language; an output generator that generates illustrative images and text in the target language based on the first input, the second input, and the speech transcript; and the output generator also synchronizes the summary, the illustrative images, and the text with the video output into a single audiovisual output that is output to the user interface.

Aspect 2: The system of Aspect 1, further including: a tutorial system, including: a viewer interface that plays the audiovisual content, displays a chat panel, and receives audio input or text input from a viewer; an audio transcriber that transcribes the audio input into a text transcript; a language detector that detects a language of the text transcript or text input; a validator including a neural network-based language model that validates the text transcript or text input; and a response generator including a large language model that generates a response to the text transcript or text input or an error message and that displays the response or error message to the chat panel.

Aspect 3: The system of Aspect 1, wherein the first input includes educational material including presentation slides.

Aspect 4: The system of Aspect 3, wherein the content generator generates quizzes based on the first input.

Aspect 5: The system of Aspect 1, wherein the output generator divides the audiovisual output into audiovisual modules.

Aspect 6: The system of Aspect 5, wherein the content generator generates a quiz for multiple audiovisual modules.

Aspect 7: The system of Aspect 5, wherein the content generator includes a neural network-based content splitter that divides the audiovisual output into modules, with modules focused on a single subtopic.

Aspect 8: The system of Aspect 1, wherein the second input includes a locale code indicating a preferred language and dialect.

Aspect 9: A method of creating audiovisual content, including: providing a user interface, including: an input receiver that receives: a first input from a user, including textual data, and a second input, including selection of options for processing the first input into an audiovisual output; and an output display that displays an audiovisual output to the user; and providing a content transformation system, including: a speech transcription engine that processes speech from the first input into a text transcription; a content generator that processes the first input and the second input and generates a speech transcript and summary in a target language; a speech generation engine that converts the speech transcript into an audio output in the target language; a speech cloning engine that converts the audio output into a cloned audio output in the target language; a video generator that generates a video output of an avatar of the user speaking the cloned audio output in the target language; an output generator that generates illustrative images and text in the target language based on the first input, the second input, and the speech transcript; and the output generator also synchronizes the summary, the illustrative images, and the text with the video output into a single audiovisual output that is output to the user interface.

Aspect 10: The method of Aspect 9, further including: providing a tutorial system, including: a viewer interface that plays the audiovisual content, displays a chat panel, and receives audio input or text input from a viewer; an audio transcriber that transcribes the audio input from the viewer into a text transcript; a language detector that detects a language of the text transcript or text input; a validator including a neural network-based language model that validates the text transcript or text input; and a response generator including a large language model that generates a response to the text transcript or text input or an error message and that displays the response or error message to the chat panel.

Aspect 11: The method of Aspect 9, wherein the first input includes educational material including presentation slides.

Aspect 12: The method of Aspect 11, wherein the content generator generates quizzes based on the first input.

Aspect 13: The method of Aspect 9, wherein the output generator divides the audiovisual output into audiovisual output modules.

Aspect 14: The method of Aspect 13, wherein the content generator generates a quiz for multiple audiovisual output modules.

Aspect 15: The method of Aspect 13, wherein the content generator includes a neural network-based content splitter that divides the audiovisual output into modules, with modules focused on a single subtopic.

Aspect 16: The method of Aspect 9, wherein the second input includes a locale code indicating a preferred language and dialect.

Aspect 17: A system for creating and managing multimedia profiles, including: a user interface that receives user input from a user, the user input including a profile name, a preferred language, and an audio video upload; a processor that processes the audio video upload by separating an audio component and a video component and transcribing the audio component into a text transcript; a database for storing the audio video upload, video component, audio component, and text transcript; a profile generator that generates an audio and video profile of the user including: a cloned avatar based on the video component, and a cloned voice profile based on the audio component; and a profile management module that displays a list of profiles and allows deletion, creation, and/or editing of the multimedia profiles.

Aspect 18: A method for creating and presenting multimedia content, including: receiving a user upload including text input, visual input, and audio input from a user; generating an avatar of the user based on the visual input; generating a voice profile based on the audio input; generating an audio output in the user’s voice of the text input using the voice profile; generating a video output using the avatar lip-synced to the audio output; and combining and synchronizing the audio output with the video output to generate the multimedia content.

Aspect 19: The method of Aspect 18, further including receiving user preferences that are used to generate the audio output and the video output.

Aspect 20: The method of Aspect 18, further including: generating related content including summaries, quizzes, and/or illustrative images based on the user upload; and displaying the multimedia content and the related content to a viewer interface.

Aspect 21: The method of Aspect 18, further including generating a URL link to the multimedia content.

Aspect 22: A system for interactive chat and multimedia content, including: a user interface that receives input from a content viewer; a processor that processes the input and generates a response; and the user interface that further displays the response as chat and/or audiovisual content.

Aspect 23: The system of Aspect 22, wherein the processor further includes: an audio transcriber that transcribes audio input from a viewer into a text transcript; a language detector that detects a language of the audio input; a validator including a neural network-based language model that validates the audio input to determine whether a response may be generated; and a response generator including a large language model that generates a response to the input or an error message.

Aspect 24: The system of Aspect 1, wherein the first input further includes one or more of video, audio, and image data.

Aspect 25: The method of Aspect 9, wherein the first input further includes one or more of video, audio, and image data.

### 10. MISCELLANEOUS; EXTENSIONS

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information, or as modules for executing these operations. Embodiments may also include methods in which steps may be performed in different order than in the example embodiments described and/or illustrated in the figures. Any of the methods described herein may be implemented as a computer program including instructions stored in a tangible non-transitory computer-readable storage medium. These instructions may be executed by one or more processors to carry out the functions described.

The language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Persons skilled in the relevant art can appreciate that many modifications and variations are possible considering the above disclosure. Accordingly, the disclosure of the embodiments is intended to be illustrative, but not limiting, of the scope of the patent rights, which is set forth in the following claims.

What is claimed is:

1. A method of creating audiovisual content, comprising:
accessing source content and stored user data, the stored user data comprising voice characteristic data and appearance data;
generating a speech transcript derived from the source content;
generating speech audio content based on the speech transcript and the voice characteristic data, the speech audio content comprising a voicing of the speech transcript in accordance with the voice characteristic data;
generating video content comprising an avatar synchronized with the speech audio content, the avatar having an appearance based on the appearance data;
combining the speech audio content and the video content to generate a synchronized audiovisual output; and
presenting the synchronized audiovisual output.

2. The method of claim 1, wherein:
the source content comprises a document including at least one slide or page, the at least one slide or page comprising at least one of text, image data, audio data, or video data;
generating the speech transcript comprises converting at least a portion of the speech transcript corresponding to the at least one slide or page based on the at least one of text, image data, audio data, or video data of the at least one slide or page;
generating the speech transcript comprises converting the document into at least one image corresponding to the at least one slide or page and generating the speech transcript based on the at least one image.

3. The method of claim 1, further comprising:
generating, based on the source content, a key phrase associated with the synchronized audiovisual output;
synchronizing the key phrase with the speech audio content based on a timing of a corresponding portion of the speech transcript; and
generating the synchronized audiovisual output to include a highlighted visual representation of the key phrase in temporal alignment with the speech audio content.

4. The method of claim 1, wherein:
generating the speech transcript comprises processing the source content using a machine learning model configured to generate narration corresponding to input source content; and
processing the source content using the machine learning model comprises:
generating a prompt including at least one of image data derived from the source content, a language identifier, prior generated content, or prior prompt-response history; and
inputting the prompt into the machine learning model to cause the machine learning model to output the speech transcript.

5. The method of claim 1, wherein:
the source content comprises a first subtopic and a second subtopic;
generating the speech transcript comprises generating a first portion of the speech transcript corresponding to the first subtopic and a second portion of the speech transcript corresponding to the second subtopic; and
the method further comprises:
segmenting the synchronized audiovisual output into a first segment corresponding to the first portion and a second segment corresponding to the second portion;
generating metadata associated with at least one of the first segment or the second segment; and
navigating to the at least one of the first segment or the second segment based on the metadata.

6. The method of claim 1, further comprising:
generating initial speech audio based on the speech transcript, wherein
generating the speech audio content further comprises modifying the initial speech audio using a stored speech sample of the voice characteristic data to generate the speech audio content.

7. The method of claim 1, wherein:
generating the video content further comprises generating the avatar based on a video of a user included in the appearance data; and
the stored user data is generated by separating an audiovisual upload of the user into an audio component and a video component;
the method further comprising:
generating the voice characteristic data based on the audio component; and
generating the appearance data based on the video component.

8. The method of claim 1, wherein:
the speech transcript comprises speech in a target language different from a source language of the source content; and
the speech transcript comprises at least one domain-specific term, in the source language, from the source content.

9. The method of claim 1, further comprising:
receiving, in association with the synchronized audiovisual output, a first query and a second query;
determining whether the first query is related to the synchronized audiovisual output; and
responsive to determining that the first query is related to the synchronized audiovisual output, generating a response to the first query based on the speech transcript;
determining whether the second query is related to the synchronized audiovisual output;
responsive to determining that the second query is not related to the synchronized audiovisual output, generating an error message.

10. The method of claim 1, further comprising:
storing the speech transcript; and
generating a subsequent output associated with the synchronized audiovisual output based on the speech transcript.

11. The method of claim 1, wherein:
the source content comprises a first page or slide and a second page or slide;
the first page or slide comprises a first additional data element;
the second page or slide comprises a second additional data element;
the first additional data element and the second additional data element comprise at least one of: a speaker note, a salient phrase, a summary, or an assessment question; and
the method further comprises:
generating a structured output comprising:
a first output portion corresponding to the first page or slide, the first output portion comprising the first additional data element; and
a second output portion corresponding to the second page or slide, the second output portion comprising the second additional data element.

12. The method of claim 1, wherein:
combining the speech audio content and the video content comprises synchronizing a plurality of audiovisual elements including at least the speech audio content, the avatar, and at least one additional data element associated with the source content, wherein
synchronizing the plurality of audiovisual elements comprises aligning the plurality of audiovisual elements on a frame-by-frame basis in the synchronized audiovisual output.

13. The method of claim 1, further comprising:
receiving a user instruction specifying at least one processing option for generating the synchronized audiovisual output, the user instruction including at least one of a language selection or a locale identifier specifying a language and dialect;
receiving audio input from a user; and
generating a text transcription of the audio input,
wherein generating at least one of the speech transcript or the speech audio content is performed based on the user instruction.

14. The method of claim 1, further comprising:
generating a structured output including at least one of a summary, a salient phrase, or an assessment question associated with the source content;
generating one or more illustrative images based on the source content, wherein the structured output and the one or more illustrative images are generated by a common content generation process based on the source content and the speech transcript;
synchronizing the structured output and the one or more illustrative images with the speech audio content in the synchronized audiovisual output; and
presenting at least a portion of the structured output to a user for review, receiving a modification to the structured output, and generating the speech transcript based on a modified structured output.

15. The method of claim 1, further comprising:
generating one or more key phrases based on the source content;
generating visual frames by overlaying highlighted representations of the one or more key phrases on images derived from the source content; and
aligning the visual frames with timestamps corresponding to portions of the speech audio content.

16. The method of claim 1, further comprising:
segmenting the synchronized audiovisual output into a plurality of segments based on at least one of: a predefined duration, a user-specified split point, a semantic boundary determined from the speech transcript, or a machine learning model identification of a subtopic boundary;
generating metadata associated with the plurality of segments;
storing the synchronized audiovisual output on a remote server;
generating a network-accessible link for accessing the synchronized audiovisual output; and
tracking interactions of one or more users with the synchronized audiovisual output to generate performance data;
presenting the performance data via a user interface to a creator associated with the synchronized audiovisual output, wherein
the plurality of segments are organized into a sequential playlist;
at least one segment of the plurality of segments comprises an automatically generated introduction or conclusion; and
at least one segment of the plurality of segments includes an assessment question associated with the segment.

17. The method of claim 1, further comprising:
receiving a query associated with the synchronized audiovisual output;
constructing a context-aware prompt including at least one of:
contemporaneously displayed audiovisual content, prior user queries, the speech transcript, one or more salient phrases, or one or more summaries associated with the synchronized audiovisual output;
generating a response to the query based on the context-aware prompt;
generating the response in a language corresponding to the query;
converting the response into synthesized speech; and
modifying the synthesized speech to correspond to the voice characteristic data.

18. One or more non-transitory computer-readable media comprising instructions which, when executed by one or more hardware processors, cause performance of operations comprising:
accessing source content and stored user data, the stored user data comprising voice characteristic data and appearance data;
generating a speech transcript derived from the source content;
generating speech audio content based on the speech transcript and the voice characteristic data, the speech audio content comprising a voicing of the speech transcript in accordance with the voice characteristic data;
generating video content comprising an avatar synchronized with the speech audio content, the avatar having an appearance based on the appearance data;
combining the speech audio content and the video content to generate a synchronized audiovisual output; and
presenting the synchronized audiovisual output.

19. A system, comprising:
an input interface;
an output interface;
a content transformation subsystem;
a datastore;
one or more hardware processors;
one or more non-transitory computer-readable media; and
instructions stored on the one or more non-transitory computer-readable media which, when executed by the one or more hardware processors, cause the system to perform operations comprising:
receiving, by the content transformation subsystem, via the input interface, source content and stored user data, the stored user data comprising voice characteristic data and appearance data;
generating, by the content transformation subsystem, a speech transcript derived from the source content;
generating, by the content transformation subsystem, speech audio content based on the speech transcript and the voice characteristic data, the speech audio content comprising a voicing of the speech transcript in accordance with the voice characteristic data;
generating, by the content transformation subsystem, video content comprising an avatar synchronized with the speech audio content, the avatar having an appearance based on the appearance data;
combining, by the content transformation subsystem, the speech audio content and the video content to generate a synchronized audiovisual output;
storing the synchronized audiovisual output in the datastore; and
presenting the synchronized audiovisual output via the output interface.
